(19) United States
(12) Patent Application Publication
(10) Pub. No.: US 2014/0075365 A1
(43) Pub. Date: Mar. 13, 2014

(54) METHOD AND SYSTEM FOR VISUALLY MONITORING THE PROGRESS OF A SECURITY OPERATION OF AN ELECTRONIC DEVICE

(71) Applicant: LOOKOUT, INC., San Francisco, CA (US)

(72) Inventors: Sophie Yuan Xie, San Francisco, CA (US); David Luke Richardson, San Francisco, CA (US); Ayan Kanti Mandal, Oakland, CA (US); Christopher Michael Jones, San Francisco, CA (US); John Gunther Hering, San Francisco, CA (US); Kevin Patrick Mahaffey, San Francisco, CA (US); Brian James Buck, Livermore, CA (US)

(73) Assignee: Lookout, Inc., San Francisco, CA (US)

(21) Appl. No.: 13/715,895

(22) Filed: Dec. 14, 2012

Related U.S. Application Data
(63) Continuation-in-part of application No. 29/431,708, filed on Sep. 10, 2012.

(51) Int. Cl. G06F 3/0481; G06F 3/048

(52) U.S. Cl. CPC G06F 3/04817
USPC 715/772

(57) ABSTRACT

Security is enhanced for a user of an electronic device by providing a method for visually monitoring the progress of a security operation on an electronic device that provides a plurality of objects including at least one of an application, a document, a file, an image, and a record. When a security operation is launched for at least some of the plurality of objects, an operation window is displayed on the electronic device's display screen. The operation window includes a first operation icon corresponding to a first object on which the security operation is currently being performed. The first operation icon includes a thumbnail icon representing the first object and an operation completion indicator that visually indicates a completion level of the security operation currently being performed on the first object.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more embodiments relate generally to handheld electronic devices and more specifically to systems and methods for visually monitoring the progress of a security operation performed on an electronic device.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Mobile electronic communication devices have evolved beyond simple telephone functionality and are now highly complex multifunctional devices with capabilities rivaling those of desktop or laptop computers. In addition to voice communications, many mobile communication devices are capable of capturing images, text messaging, e-mail communications, internet access, social networking, and running full-featured application software. A full range of mobile applications are available from online application stores that can be downloaded onto mobile communication devices. These applications can be games and/or services that provide additional capabilities. Moreover, mobile communication devices can support storage capabilities to locally store images, documents, files, and/or records that can be accessed offline by a user.

With so many objects provided by the mobile communication device, the risk of downloading malicious code increases and the chances of harboring and/or passing on a virus or worm are high. To address this threat, security software for mobile communication devices is now available to detect and remove suspicious code. Typically, the security software performs a series of security operations automatically when the device is powered on, when a predetermined period of time has elapsed, and/or when launched by the user. A security operation can include scanning all or at least some of the applications to detect malware, issuing an alert to the user when such code is detected, and if instructed, removing the malicious code. In addition, a security operation can include backing up data.

When security operations are being performed by the mobile communication device, it can be difficult for a user to know at a glance what operations have already been performed, what operations are currently ongoing, and what operations have not yet been performed. Although in some cases, a percentage of completion and/or an indication of how much time is remaining for the entire process is provided, there is no indication of which application has been scanned or which image or file has not yet been backed up.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is a block diagram illustrating an electronic device according to an embodiment;

FIG. 2 is an operational flow diagram illustrating a high level overview of an exemplary method for visually monitoring the progress of a security operation on an electronic device according to an embodiment;

FIG. 3A and FIG. 3B illustrate exemplary operation windows according to exemplary embodiments; and

FIGS. 4A, 4B, and 4C illustrate exemplary information windows according to embodiments.

### DETAILED DESCRIPTION

It should be appreciated that the present invention can be implemented in numerous ways, including as a process, an apparatus, a system, a device, a method, or a computer readable medium such as a computer readable storage medium containing computer readable instructions or computer program code, or a computer network wherein computer readable instructions or computer program code are sent over optical or electronic communication links. Applications, software programs or computer readable instructions may be referred to as components or modules. Applications may take the form of software executing on a general purpose computer or be hardwired or hard coded in hardware. Applications may also be downloaded in whole or in part through the use of a software development kit, framework, or toolkit that enables the creation and implementation of the present invention. In this specification, these implementations, or any other form that the invention may take, may be referred to as techniques. In general, the order of the steps of disclosed processes may be altered within the scope of the invention.

Systems and methods are provided for visually monitoring the progress of a security operation on an electronic device that hosts applications and stores documents, files, records, and images. The applications, documents, files, records, and images are collectively referred to as objects. In an embodiment, the inventive systems and methods permit a user of the electronic device to determine, at a glance, on which objects the security operation has been performed, on which object the security operation is currently being performed, and on which objects the security operation has not yet been performed.

According to an embodiment, when the security operation is launch for at least some of the objects, an operation window is displayed and includes, among other things, a first operation icon corresponding to a first object on which the security operation is currently being performed. In an embodiment, the first operation icon includes a thumbnail icon representing the first object and an operation completion indicator that visually indicates a completion level of the security operation currently being performed on the first object.

As used herein, the term “mobile communication device” refers to mobile phones, tablets, PDAs and smartphones. The term “mobile communications device” also refers to a class of laptop computers which run an operating system that is also used on mobile phones, tablets, PDAs, or smartphones. Such laptop computers are often designed to operate with a continuous connection to a cellular network or to the internet via a wireless link. Specifically, mobile communication devices include devices for which wireless communication services such as voice, messaging, data, or other wireless Internet capabilities are a primary function. As used herein, a “mobile communication device” may also be referred to as an “electronic device,” an “electronic client device,” “mobile device,” “mobile client,” or “handset.” However, a person having skill in the art will appreciate that while the present invention is disclosed herein as being used on mobile communication devices, the present invention may also be used on other computing platforms, including desktop, laptop, notebook, netbook, or server computers.

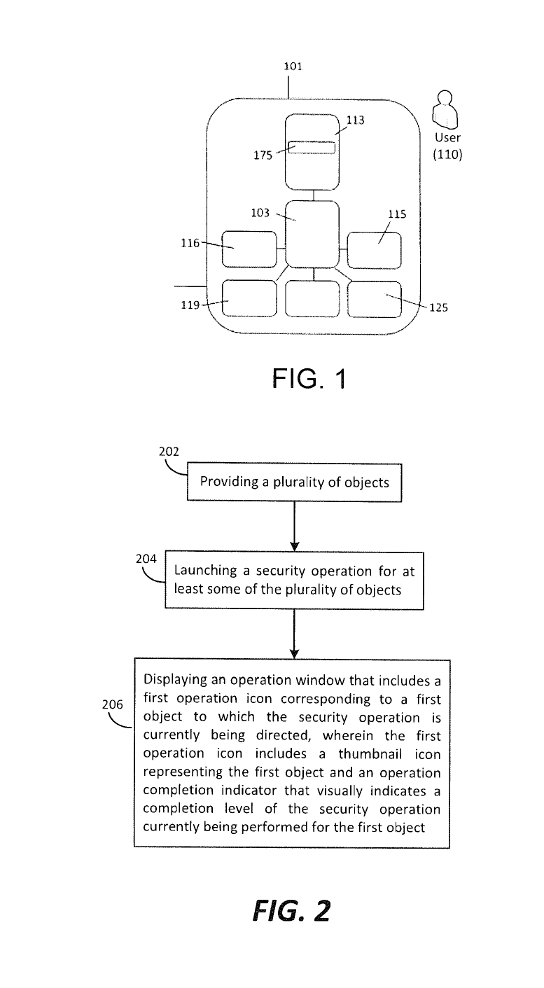

Prior to describing the subject matter in detail, an exemplary mobile communication device in which the subject matter may be implemented shall first be described. Those of ordinary skill in the art will appreciate that the elements illustrated in FIG. 1 may vary depending on the system implementation. With reference to FIG. 1, a block diagram of an embodiment of the mobile communication device 101 is illustrated. The mobile device 101 includes: an operating system 113, an input device 115, a radio frequency transceiver(s) 116, a visual display 125, and a battery or power supply 119. Each of these components is coupled to a central processing unit (CPU) 103. The device operating system 113 runs on the CPU 103 and enables interaction between application programs and the mobile device hardware components. In an embodiment, the mobile device 101 receives data through an RF transceiver(s) 116 which may be able to communicate via various networks, for example: Bluetooth, local area networks such as WiFi, and cellular networks such as GSM, CDMA or LTE.

In an embodiment, a local software component 175 is an application program that is downloaded to a mobile device and installed so that it integrates with the operating system 113. Much of the source code for the local software component 175 can be re-used between various mobile device platforms by using a cross-platform software architecture. In such a system, the majority of software functionality can be implemented in a cross-platform core module. The cross-platform core can be universal allowing it to interface with various mobile device operating systems by using a platform-specific module and a platform abstraction module that both interact with the mobile device operating system 113, which is described in U.S. patent application Ser. No. 12/255,626, entitled “SYSTEM AND METHOD FOR A MOBILE CROSS-PLATFORM SOFTWARE SYSTEM.” In another embodiment, the local software component 175 can be device, platform or operating system specific.

The mobile device 101 may operate in a networked environment using logical connections to one or more remote nodes via a communication interface. The remote node may be another computer, a server, a router, a peer device or other common network node, and typically includes many or all of the elements described above relative to the mobile device 101. The communication interface may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like.

It should be understood that the arrangement of mobile communication device 101 illustrated in FIG. 1 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) can be realized, in whole or in part, by at least some of the components illustrated in the arrangement of mobile device 101. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 1. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description that follows, the subject matter will be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the device, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

FIG. 2 is a flow diagram illustrating a method for visually monitoring the progress of a security operation on an electronic device according to an exemplary embodiment. The method illustrated in FIG. 2 can be carried out by, for example, at least some of the components in the exemplary mobile communication device illustrated in FIG. 1, but can also be carried out in environments other than that illustrated in FIG. 1. According to an embodiment, the method 200 begins, in block 202, when a plurality of objects including an application, a document, a file, an image, and/or a record are provided by an electronic device such as a mobile communication device 101. As described above, such a device is capable of hosting and downloading an assortment of mobile applications including games and services. Additionally, it is capable of storing documents, images, files and/or records.

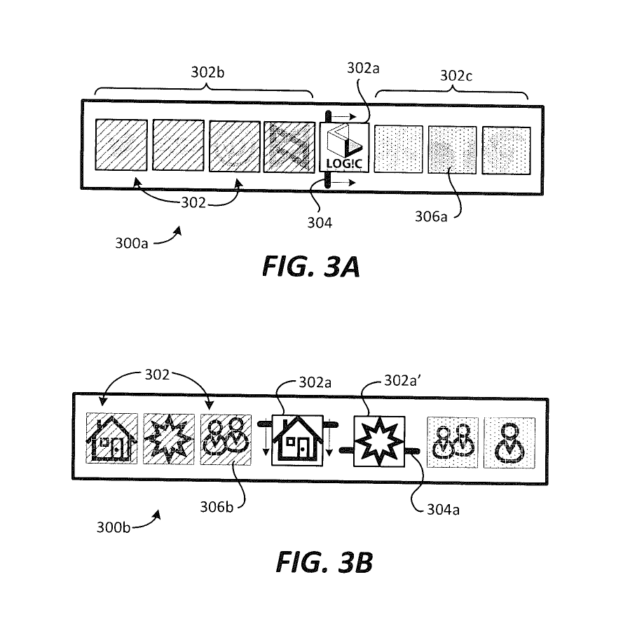

When a security operation is launched for at least some of the objects, in block 204, an operation window can be displayed on a display screen, e.g., 125, of the electronic device in block 206. FIG. 3A and FIG. 3B illustrate exemplary operation windows displayed in a display screen 125 of an electronic device 101. According to an embodiment, the operation window 300a, 300b includes a plurality of operation icons 302 corresponding to a plurality of objects on which the security operation was performed, is being performed, or will be performed. In an embodiment, the operation icons 302 can be arranged horizontally in chronological order by when the security operation for each corresponding object was, is being, or will be performed.

According to an embodiment, each operation icon 302 includes a thumbnail icon representing the object corresponding to the operation icon 302. The thumbnail icon is generated based on the nature of the security operation being performed. For example, when the security operation is a malware scan of a plurality of applications, the thumbnail icon representing an application object can be a graphic logo 306a associated with the application. Alternatively or in addition, when the security operation is a backup of a plurality of images, the thumbnail icon representing an image object can be a thumbnail image 306b of the image object.

According to an embodiment, the plurality of operation icons 302 includes a first operation icon 302a corresponding to a first object on which the security operation is currently being performed. According to an embodiment, the security operation can be performed on more than one object simultaneously and therefore, more than one first operation icon 302a, 302a′ corresponding to more than one first object can be displayed in the operation window 300b as shown in FIG. 3B. In an embodiment, in addition to the thumbnail icon representing the first object, the first operation icon 302a also includes an operation completion indicator 304 that visually indicates a completion level of the security operation currently being performed on the first object.

In an embodiment, the completion indicator 304 can be a vertical bar extending above, below and behind the thumbnail icon, and moving in a direction along a horizontal axis of the first operation icon 302a from left to right, as is shown in FIG. 3A. When the security operation for the first object begins, the completion indicator 304 can appear and be positioned at or near the left hand corner of the operation icon 302a. As the security operation progresses, the vertical bar 304 can move progressively closer to the right hand corner. For example, in an embodiment, when the security operation is completed halfway, the completion indicator 304 can be positioned midway between the left and right hand corners, and when the security operation is nearing completion, the completion indicator 304 can be positioned at or near the right hand corner of the operation icon 302a. In this manner, a user 110 of the electronic device can easily determine the completion percentage of the security operation for the first object with a quick glance.

Alternatively, or in addition, the completion indicator 304a can be a horizontal bar extending beyond the right and left sides of the thumbnail icon, and moving in a direction along a vertical axis of the first operation icon 302a from top to bottom, as is shown in FIG. 3B. In this case, at the beginning of the security operation for the first object, the completion indicator 304a can be positioned at or near the top corner of the operation icon 302a, and as the security operation progresses, the bar 304a can move progressively closer to the bottom corner. For example, in an embodiment, when the security operation is completed halfway, the completion indicator 304a can be positioned midway between the top and bottom corners, and when the security operation is nearing completion, the completion indicator 304a can be positioned at or near the bottom corner of the operation icon 302a. Once the security operation on the first object is completed, the completion indicator 304a is removed.

According to an embodiment, at least one second operation icon 302b corresponding to at least one second object on which the security operation has been performed and completed can also be displayed in the operation window 300a, 300b. In addition, at least one third operation icon 302c corresponding to at least one third object on which the security operation has not yet been performed can also be displayed in the operation window 300a, 300b. In an embodiment, the visual appearance of the second operation icons 302b can be different from the visual appearance of the third operation icons 302c so that the user 110 can easily determine, at a glance, on which objects the security operation has been performed or has yet been performed.

For example, the backgrounds of the second 302b and third 302c operation icons can be differently shaded, as shown in FIG. 3A and FIG. 3B, or can be differently colored. The second 302b, but not the third 302c, operation icons can be underlined, or have an adjacent visual indicator, above or below each second operation icon 302b, such as a check mark. In another embodiment, the third 302c, but not the second 302b, operation icons can have a visual indicator, such as the expected time at which the security operation will commence, displayed vertically adjacent, above or below, each third operation icon 302b.

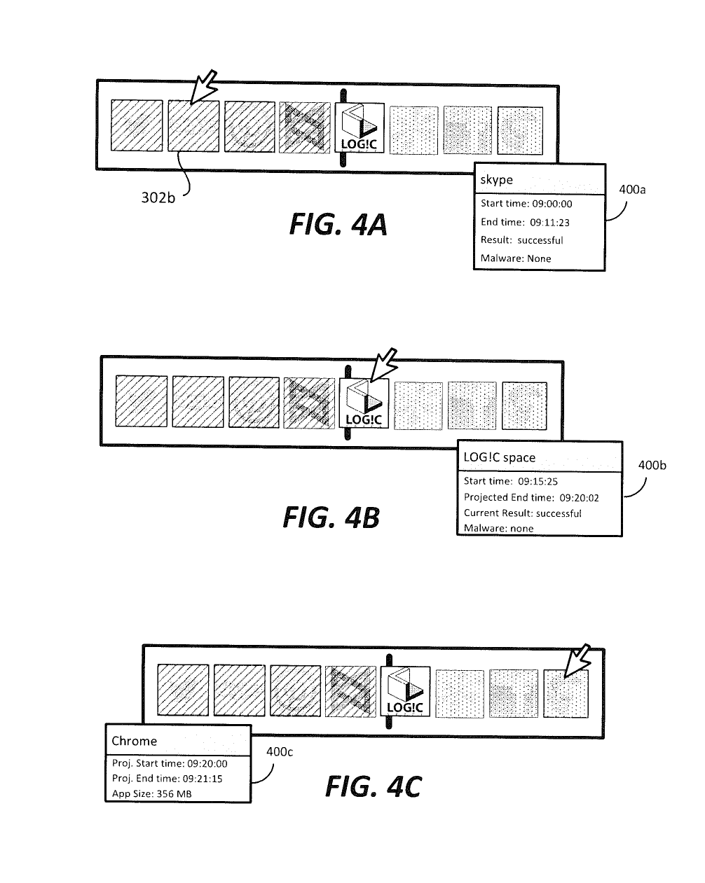

In an embodiment, the user 110 of the device can discover more detailed information relating to the security operation performed, being performed, or to be performed on an object by selecting the operation icon 302 corresponding to the object of interest. In response to receiving such a selection, an information window can be displayed that includes the detailed security operation information. For example, in FIG. 4A, when the user 110 selects a second operation icon 302b corresponding to a second object on which the security operation has been performed, an information window 400a can be displayed that includes a start time and an end time of the security operation, the success or failure of the security operation, and additional details about the security operation, such as what malware may have been found in a security malware scan, or the size of the image that was backed up.

In another embodiment, when the user 110 selects a first operation icon 302a corresponding to a first object on which the security operation is being performed, as shown in FIG. 4B, another information window 400b can be displayed that includes the start time of the security operation, the projected end time, partial results of the security operation, and additional details about the security operation, such as what malware may have been already found in a security malware scan, or the total size of the image that is being backed up and what percentage of it has already been backed up. Alternatively, or in addition, when the user 110 selects a third operation icon 302c corresponding to a third object on which the security operation has not yet been performed, as shown in FIG. 4C, another information window 400c can be displayed that includes the projected start time of the security operation, the projected end time, the size of the application or image, and other information.

Any of the above embodiments may be used alone or together with one another in any combination. The one or more implementations encompassed within this specification may also include embodiments that are only partially mentioned or alluded to or are not mentioned or alluded to at all. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

In addition, one will appreciate that in the description above and throughout, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for visually monitoring the progress of a security operation on an electronic device including a display screen, the method comprising:
providing, by an electronic device, a plurality of objects including at least one of an application, a document, a file, an image, and a record;
launching, by the electronic device, a security operation for at least some of the plurality of objects; and
displaying, by the electronic device on its display screen, an operation window that includes a first operation icon corresponding to a first object on which the security operation is currently being performed, wherein the first operation icon includes a thumbnail icon representing the first object and an operation completion indicator that visually indicates a completion level of the security operation currently being performed on the first object.

2. The method of claim 1 wherein the completion indicator is a vertical bar extending above, below and behind the thumbnail icon and wherein a horizontal position of the vertical bar changes along a horizontal axis of the thumbnail icon based on a completion percentage of the security operation for the first object.

3. The method of claim 1 further comprising displaying in the operation window at least one second operation icon corresponding to at least one second object on which the security operation has been performed and completed, wherein the at least one second operation icon includes at least one thumbnail icon representing each of the at least one second object.

4. The method of claim 3 further comprising displaying in the operation window at least one third operation icon corresponding to at least one third object on which the security operation has not yet been performed, wherein the at least one third operation icon includes at least one thumbnail icon representing each of the at least one third object.

5. The method of claim 4 wherein the first, second, and third operation icons are arranged horizontally in the operation window in chronological order by when the security operation for each corresponding object was performed, is being performed, or will be performed.

6. The method of claim 4 further comprising:
receiving an indication selecting a second operation icon or a third operation icon; and
displaying, on the display screen, an information window including information relating to the security operation performed or to be performed, the information including at least one of an actual start time, a protected start time, an actual end time, a projected end time, and results.

7. The method of claim 1 wherein the security operation can be directed to more than one object simultaneously, the method further comprising:
displaying, in the operation window, another first operation icon corresponding to another first object on which the security operation is currently being performed, wherein the other first operation icon includes a thumbnail icon representing the other first object and an operation completion indicator that visually indicates a completion level of the security operation currently being performed on the other first object.

8. The method of claim 1 wherein when the security operation is a malware scan of a plurality of applications, the thumbnail icon representing an application object includes a graphic logo associated with the application.

9. The method of claim 1 wherein when the security operation is a backup of a plurality of images, the thumbnail icon representing an image object includes a thumbnail image of the image object.

10. The method of claim 1 further comprising:
receiving an indication selecting the first operation icon; and
displaying, on the display screen, an information window including information relating to the security operation currently being performed on the first object, the information including at least one of a start time, a projected end time, and partial results.

11. A method for visually monitoring the progress of a security operation on an electronic device including a display screen, the method comprising:
providing, by an electronic device, a plurality of objects including at least one of an application, a document, a file, an image, and a record;
launching, by the electronic device, a security operation for at least some of the plurality of objects; and
displaying, by the electronic device on its display screen, an operation window that includes:
a first operation icon corresponding to a first object on which the security operation is currently being performed, wherein the first operation icon includes a thumbnail icon representing the first object and an operation completion indicator that visually indicates a completion level of the security operation currently being performed on the first object;
at least one second operation icon corresponding to at least one second object on which the security operation has been performed and completed, wherein the at least one second operation icon includes at least one thumbnail icon representing each of the at least one second object; and
at least one third operation icon corresponding to at least one third object on which the security operation has not yet been performed, wherein the at least one third operation icon includes at least one thumbnail icon representing each of the at least one third object.

12. A non-transitory computer-readable medium carrying one or more sequences of instructions for visually monitoring the progress of a security operation on an electronic device, which instructions, when executed by one or more processors, cause the one or more processors to perform operations comprising:
providing a plurality of objects including at least one of an application, a document, a file, an image, and a record;
launching a security operation for at least some of the plurality of objects; and
displaying an operation window that includes a first operation icon corresponding to a first object on which the security operation is currently being performed, wherein the first operation icon includes a thumbnail icon representing the first object and an operation completion indicator that visually indicates a completion level of the security operation currently being performed on the first object.

13. The computer-readable medium of claim 12 wherein the completion indicator is a vertical bar extending above and below the thumbnail icon and wherein a horizontal position of the vertical bar changes along a horizontal axis of the thumbnail icon based on a completion percentage of the security operation for the first object.

14. The computer-readable medium of claim 12 wherein the instructions further cause the processors to perform operations comprising displaying in the operation window at least one second operation icon corresponding to at least one second object on which the security operation has been performed and completed, wherein the at least one second operation icon includes at least one thumbnail icon representing each of the at least one second object.

15. The computer-readable medium of claim 14 wherein the instructions further cause the processors to perform operations comprising displaying in the operation window at least one at least one third operation icon corresponding to at least one third object on which the security operation has not yet been performed, wherein the at least one third operation icon includes at least one thumbnail icon representing each of the at least one third object.

16. The computer-readable medium of claim 15 wherein the instructions further cause the processors to perform operations comprising:
receiving an indication selecting a second operation icon or a third operation icon; and
displaying, on the display screen, an information window including information relating to the security operation performed or to be performed, the information including at least one of an actual start time, a protected start time, an actual end time, a projected end time, and results.

17. The computer-readable medium of claim 12 wherein the security operation can be directed to more than one object simultaneously, and wherein the instructions further cause the processors to display, in the operation window, another first operation icon corresponding to another first object on which the security operation is currently being performed, wherein the other first operation icon includes a thumbnail icon representing the other first object and an operation completion indicator that visually indicates a completion level of the security operation currently being performed on the other first object.

18. The computer-readable medium of claim 12 wherein when the security operation is a malware scan of a plurality of applications, the thumbnail icon representing an application object includes a graphic logo associated with the application.

19. The computer-readable medium of claim 12 wherein when the security operation is a backup of a plurality of images, the thumbnail icon representing an image object includes a thumbnail image of the image object.

20. The computer-readable medium of claim 12 wherein the instructions further cause the processors to perform operations comprising:
receiving an indication selecting the first operation icon; and
displaying, on the display screen, an information window including information relating to the security operation currently being performed including at least one of a start time, a projected end time, and partial results.
